(19) United States
(12) Patent Application Publication
(10) Pub. No.: US 2017/0011133 A1
(43) Pub. Date: Jan. 12, 2017

(54) SYSTEM AND METHOD FOR IMPROVING WEBPAGE LOADING SPEEDS

(71) Applicant: OPEN GARDEN INC., San Francisco, CA (US)

(72) Inventors: Stanislav Shalunov, Lafayette, CA (US); Gregory Hazel, San Francisco, CA (US); Micha Benoliel, San Francisco, CA (US)

(21) Appl. No.: 14/758,961

(22) PCT Filed: Mar. 31, 2015
(86) PCT No.: PCT/US15/23698

§ 371 Date: Jul. 2, 2015

Related U.S. Application Data
(60) Provisional application No. 61/973,127, filed on Mar. 31, 2014.

(51) Int. Cl. G06F 17/30; H04L 29/08; G06F 17/27

(52) U.S. Cl. CPC G06F 17/30902; G06F 17/272; G06F 17/30896; H04L 67/02

(57) ABSTRACT

Speeding up webpage loading by utilizing one or a combination of the following techniques: heuristic pre-loading; increasing the number of connections to a server; resource caching; and, distributed DNS caching. A software module is inserted between the browser and the server, so as to perform the heuristic preloading, to increase the number of connections, to perform wireless caching of resources and DNS query responses. The software module may be placed in various places in the technology stack, for example, inside a home router or in a separate box connected to one's router. The module can insert itself by using proxy discovery protocols, or intercepting the traffic going to the router by issuing ARP replies that look as if it is the router. Alternatively, it could overwrite DHCP.

### RELATED APPLICATIONS

This Application claims priority benefit from U.S. Provisional Application Ser. No. 61/973,127, filed on Mar. 31, 2014, the disclosure of which is incorporated herein in its entirety.

### BACKGROUND

### 1. Field

This disclosure relates to loading of webpages into computing devices and is most beneficial for accelerating loading of pages, especially onto mobile computing devices.

### 2. Related Art

The disclosure provided herein is applicable to any computational device used for viewing web pages, and is especially beneficial for mobile devices. Also, the disclosed embodiments accelerate loading webpages especially for devices using wireless communication in addition to or instead of wired communication. FIG. 1 is a schematic illustrating the default baseline condition of a device establishing a single connection to a server for downloading a webpage, according to the prior art. As experienced by many users, in many occasions downloading and rendering of the webpage is slow. Therefore, improving speeds for webpage loading is desirable in any environment. This is especially true in environments where web pages load slowly, e.g., using a single wireless connection of a mobile device. Such environments may exist when a browser is running on a device with any combination of: poor connectivity, a slow processor, and/or limited memory.

In the example of FIG. 1, the browser has a single connection to the server and sends requests to the server for the website and resources required for rendering the website. However, the browser does not start to fetch resources from the server until it is completely certain that those resources will be required. Before it can obtain this certainty, it needs to download the HTML file of the page, parse the HTML, construct the document object model (DOM), and then start fetching additional resources from the server to render the page. Such additional resources may include Javascript code and cascading style sheets (CSS), as indicated in the downloaded and parsed webpage. Only by executing the scripts can the browser determine the complete contents of the page. Hence the first Javascript that the browser interprets may contain within its Javascript code references to additional scripts, which delays further the time at which a browser can completely determine all elements to render a page.

Moreover, all of the fetching is done serially by sending each request separately and waiting for the response from the server to be completely downloaded before sending the second request.

### SUMMARY

The following summary of the disclosure is included in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

Disclosed embodiments speed up web loading by utilizing one or a combination of the following techniques: heuristic pre-loading; increasing the number of connections to a server; resource caching (both in wired and wireless networks); and, distributed DNS caching. All four of these techniques are applicable in all networks, but especially in mobile networks, and even more especially, in mobile mesh networks. In tests when these improvements were applied to fixed networks, they gave a 3× factor improvements.

According to disclosed embodiments, a software module is inserted between the browser and the server, so as to perform heuristic preloading, to increase the number of connections, to perform wireless caching of resources and DNS query responses. The software module may be placed in various places in the technology stack, for example, inside a home router or in a separate box connected to one's router. The module can insert itself by using proxy discovery protocols, or intercepting the traffic going to the router by issuing ARP replies that look as if it is the router. Alternatively, it could overwrite DHCP. There are a variety of techniques it could use to become the proxy and the specific technique implemented is not important. Once the module inserted itself as a proxy, whether transparent or explicit, it can speed up traffic, especially downloading of webpages and their resources. It is even possible to place this device in a different computer on the network. Adding this proxy to one's computer can speed up behavior on one's mobile phone, if the phone is connecting via the computer. There could be a router at the ISP that performs this function, or it could be an appliance in the ISP premises. End users may not even be aware of the existence of this module, but will benefit nonetheless. Note also that while an optimal implementation uses all four of the techniques described below of heuristic preloading, adding connections, wireless caching, and DNS caching, beneficial speedups may be gained with any subset of them.

According to disclosed embodiments, a computerized method for speeding up the downloading and rendering of web pages from a server is provided, by which, during download and parsing of an HTML document by a browser, scanning of the HTML document for mention of a resource is performed; and upon encountering mention of a resource, fetching the resource from the server prior to the browser requesting the resource. Identifying a resource in the webpage may be performed by scanning the webpage for tag types, e.g., <script>, file types, .js, .css, or specific text characters.

According to further disclosed embodiments, a computerized method for speeding up the downloading and rendering of web pages from a server is provided, according to which, the number of connections between the browser and the hosting server is increased in correlation to the number of resources listed in a downloaded webpage. Whether to establish a new connection may be determined based on examination of at least one of: number of resources listed in the webpage, size of the resource, bandwidth of available physical connections, and network traffic. In one example, a new connection is established for each listed resource, and the resource is requested and downloaded via the newly established connection. In some embodiments, the new connections are established by a proxy, irrespective of the browser request for resources.

According to further disclosed embodiments, a computerized method for speeding up the downloading and rendering of web pages from a server is provided, according to which, whenever a webpage resource is requested from a website server, the resource sent by the website server is cached in a node of a network and when another request is made for the same resource, the resource is provided from the node and the request is not sent to the website server.

According to further disclosed embodiments, a computerized method for speeding up the downloading and rendering of web pages from a server is provided, according to which, a distributed DNS caching table is built in the network. Whenever a DNS request is issued by a device connected to the network, it is first determined whether the requested DNS has already been cached in the distributed DNS caching network and, if so, the cached response is fetched and forwarded to the device; otherwise the DNS request is forwarded to a DNS server.

Other aspects and features of the invention would be apparent from the detailed description, which is made with reference to the following drawings. It should be appreciated that the detailed description and the drawings provides various non-limiting examples of various embodiments of the invention, which is defined by the appended claims.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 is a schematic illustrating the default baseline condition of a device establishing a single connection to a server for downloading a webpage, according to the prior art.

FIG. 2 is a high-level flow chart illustrating a process according to one embodiment.

FIG. 3 is a schematic illustrating the condition of a device establishing multiple connections to a server for concurrent downloading a webpage and resources, according to one embodiment.

FIG. 4 is a schematic illustrating an embodiment in which the technique of wireless caching may be profitably employed.

FIG. 5 is a schematic illustrating direct communication between devices A and B, while FIG. 6 is a schematic illustrating an embodiment wherein a proxy intercepts the communications between devices A and B.

FIG. 7 illustrates an embodiment utilizing tree shaking

### DETAILED DESCRIPTION

The disclosure now turns to detailed description of various features and embodiments. As noted, each of the disclosed features help increasing download speed of webpages. However, improved results can be achieved by incorporating several, or indeed, all of the disclosed features into a single central or distributed solution.

### 1. Heuristic Prefetching

As explained in the Background section, prior art browsers download and parse the entire webpage before fetching any resources that may be required for rendering the page. However, it is not necessary to have determined with complete certainty that a resource will be needed for the browser to begin downloading it. If, for example, it is possible to infer with high degree of confidence, even if not complete certainty, that a resource will be necessary, then according to one embodiment download the resource commences regardless of the downloading state of the rest of the page or its resources. This represents a departure from modern browsers behavior, which, to repeat, is to first download the entire HTML file (which mentions numerous resources) and then determine all the necessary resources through the process of fully parsing the HTML file, complying with the complete formal specification of HTML (i.e. using a so-called compliant parser.)

According to disclosed embodiment, an alternate approach is implemented by downloading all resources named in the HTML file as soon as possible, and then downloading resources named in those initially downloaded resources, and so on. By doing this, it is possible that resources that prove to be unnecessary were also downloaded. However, this occur a small percentage of the time in practice.

Modern web browsers delay downloading resources, which often lengthens the overall elapsed time required to render and display a page. Conversely, disclosed embodiments utilize techniques that, in themselves may not constitute fully compliant HTML parsing, but can achieve speedups of web downloading by initiating the downloading of resources which are likely to be required. Some examples of techniques for identifying the resources include general implementation of pattern matching. Pattern matching may be implemented by one or more of the following examples:

1. regular expression matching

2. string matching

3. searching for specific text characters

According to one embodiment, rather than waiting for complete certainty that a particular resource may be needed, the resource is downloaded if there's reasonable confidence that it will be required. For example, if a resource is mentioned in an HTML page, rather than wait for a rigorous verification that the resource will in fact be required, it is downloaded even during the scanning of the initial HTML file. According to some embodiments, resources are identified by locating in the HTML file specific mentions resources, indicated by, for example:

1. tag types, e.g. <script>

2. file types, e.g., .js, .css

3. specific text characters, e.g. quotation marks (“and”)

For example, if an HTML file references a CSS style sheet, it will be downloaded, even if there is a chance that conditional interpretation of the HTML may reveal that this CSS file is never used. This technique is referred to herein as heuristic preloading. This works effectively since the likelihood of a named resource being unnecessary is low, while in the likely event that the resources is indeed needed, we gain a significant improvement in performance. This straightforward cost-benefit analysis shows the value of heuristic preloading, and is borne out by empirical tests which, in combination with other techniques, showed a speedup of a factor of three (3×).

Note that fully compliant HTML parsing and heuristic preloading are independent behaviors of web browsers. While compliance only requires downloading what is necessary, nothing prevents a browser implementation from including a heuristic preloading stage prior to the compliant parsing stage. Hence, heuristic preloading does not make a compliant parser non-compliant. Nevertheless, current compliant browsers do not presently do heuristic preloading.

A fully compliant HTML parser determines which, if any, lines of HTML source are never executed as a result of conditional interpretation. This permits a browser to then not download resources that are requested in unused HTML code. This full compliance, however, requires more time, especially because it must tolerate (and recover from) HTML source code errors. Moreover, standard HTML may be rife with browser-slowing quirks that a fully compliant HTML parser must handle.

Various embodiments may utilize different choices concerning the order in which resources are downloaded. Consider the case where a resource mentioned in the HTML file is a script that references other scripts, which in turn references additional scripts and other resources. This may be considered as defining a tree (or possibly a directed graph) in which:
each node represents a resource
the root represents the original HTML document
a node representing a resource R has child nodes that correspond to resources referenced in R.

The optimal order in which the resources should be downloaded may vary, e.g. depth-first traversal (either pre-order, in-order, or post-order), a breadth-first traversal (i.e., visit every node on a level before going to a lower level), or some variation, as the disclosed embodiments can work with any possible ordering. In practice, the depth of the tree is very shallow, so the question is generally moot. Regardless of the depth, the heuristic likely to be optimal is to simply download each resource as soon as it is encountered. This implies that a resource download may initiate even before completing the downloading and scanning of the HTML document itself. Moreover, in some embodiments described below, a new connection may be opened for each resource encountered, so resources may be downloaded in parallel, and resource download completions may not occur in the same order as resource download initiations anyway.

FIG. 2 is a high-level flow chart illustrating a process according to one embodiment. In FIG. 2, at 200 a browser sends an HTML page request in the standard manner. Once the server receives the request, it sends an HTML page back to the browser, at 205. On the right side of FIG. 2, the process proceeds as in the prior art. However, on the left side the process branches and performs additional steps, e.g., using a proxy. As shown, on the right hand side at 210 the browser parses the HTML page, at 215 the browser constructs document object model (DOM), at 220 it determines the resources needed for rendering the page, at 225 the browser requests the resources from the server, and in 230 the browser renders the page. On the left side, at 240 a parallel process scans the HTML page as it is received to find indications of potentially needed resources. At 245 the parallel process sends requests for these potential resources, over one or multiple connections to the website hosting server. At 250 the parallel process receives and stores the requested resources. Consequently, when the browser determines that a specific resource is needed for rendering the page, it may have already been fetched by the parallel process and available immediately without sending a request to the server, thus the time from sending the initial request to rendering the page is shortened.

Another innovative feature that may be incorporated in the heuristic pre-loader is referred to herein as tree shaker. Sometimes it is possible to determine that some resources are referred to in the HTML page, but never actually used by the page. In this case, the browser may erroneously download these resources anyway, even when they won't be needed. Examples include:
style sheets that refer to nonexistent elements
JavaScript code that is never invoked
outdated (and so unused) company logos and other graphic elements
fonts that are never used.

For example, at the time of this writing, pages on Apple's website contain an unused font file that represents a majority of the content downloaded to render the page. Since such resources are not used, it is better to eliminate downloading them entirely; the resulting savings are frequently significant. There are many other such examples. This is a compiler optimization technique: determine whether a code is never executed and, if so, do not include it. Tree shaking is most efficient either at the source or close to the source. There are three reasonable places tree shaking may be deployed: in an appliance near the server, in an appliance near a router, or on the hosting server itself

According to one embodiment, the DOM tree is traversed and all resources used are enumerated. Anything not touched during the traversal is, in fact, unused. Consequently, if a request from the browser is for a resource that was not enumerated during the tree shaking traversal, the request is intercepted and not forwarded to the server. An HTTP error may be returned instead, while the requested resource is not downloaded. Alternatively, the system could return a minimized placeholder, such as a one-pixel image for images, an empty CSS file, or a font with no characters, but this risks polluting the cache.

Browser's representation of the parsed DOM is only available within the browser. Parsed DOM is the most reliable way to get the tree right, and, consequently, when the system is operating within the browser, rather than as a proxy or an appliance, it makes sense to use the browser-constructed DOM. Thus, the tree shaker process is most suitable for embodiments when the system is operating within the browser. In embodiments wherein the system operates as a proxy, it may also parse the DOM, but that is a lot of work. When the proxy is running on a mobile device, for example as an app, the cost of parsing the DOM twice may not be acceptable, either in terms of battery or the additional latency. Therefore, in such embodiments it is often better to implement the text matching techniques process described above for prefetching, rather than perform tree shaking This is especially since fonts and images are particularly easy to identify textually when they are not used.

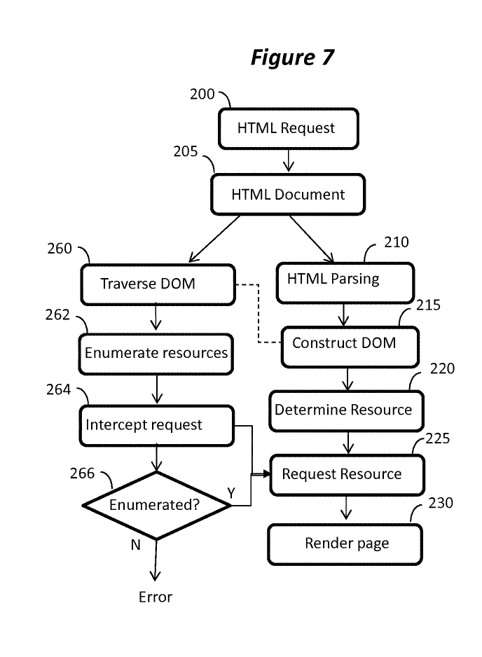

As illustrated in FIG. 7, when the browser constructs the DOM, the tree shaking process proceeds by traversing the DOM in step 260, so as to identify all of the resources that are necessary to construct the page. These necessary resources are enumerated in step 262. In step 264, the process intercepts resource request from the browser and in step 266 checks whether the resource requested was enumerated in step 262 such that the resource was identified as necessary during the traversal of the DOM. If so, the request is relayed to the server, or the resource is fetched from a cache. Conversely, if the requested resource has not been identified, the process returns an error. Incidentally, if the request is already outstanding (i.e., already sent to the server but a response not yet received from the server) and tree shaking process finds it unnecessary, the system may close the connection and not await the server sending the resource. The request might be outstanding because of the prefetching techniques or because the browser sent it normally. FIG. 2 illustrates the situation wherein the tree shaking is implemented in an embodiment that also implements a prefetching process. In this case, it is likely that the prefetching process is fast and may start downloading resources before the browser completes the parsing of the page and creating the DOM. Thus, the tree shaking process may not have began. Once the tree shaking process starts, it may find that requests for unnecessary resources have already been issued, and thus may close the connection for these requests.

Browsers must necessarily accept non-compliant HTML since so much exists “in the wild.” Browsers must make every effort to handle such flawed HTML code as gracefully as possible by making the best guess about how to render it. These techniques are necessary for full, complete, compliant HTML parsing, but they cost CPU time, which makes fully compliant HTML parsing even longer. By comparison, heuristic prefetching requires much less time, since identifying resource tags and file types by using pattern matching techniques mentioned above, is computationally fast. Using these pattern matching techniques, the system identifies additional resources and downloads them while the browser is parsing HTML. In practice, resources can be fetched considerably sooner than waiting for the browser to complete parsing the page—possibly hundreds of milliseconds or more sooner. As a result, when the browser finally recognizes and requests the resources it needs, the system makes them immediately available since they were already downloaded and stored locally. This enables the browser to render HTML pages far more quickly. Over the multitude of web page resource requests and their fulfillment, time delays in the absence of heuristic preloading are additive and adversely affect the user experience. Heuristic preloading vastly improves the user experience.

### 2. Increasing the Number of Connections to a Server

Javascript scripts can perform arbitrary rewrite operations on web pages. Therefore, the general task for a compliant browser of determining which resources a page requires, and must therefore be downloaded, is Turing-complete, and can therefore require an arbitrarily long time to complete. Browsers must be prepared to handle this situation. Fortunately, in average, or typical cases, the majority of resources are available without this additional computation.

Using the above-disclosed heuristic prefetching, the process identifies all resources named in the HTML code for a page and the scripts it contains, and immediately downloads them. It may be necessary for the browser to download additional resources, since, for example, scripts may reference other scripts. This does not present a problem, since it is not necessary for the parallel process to identify 100% of the necessary resources to obtain a significant improvement of download time.

In general, due to a recommendation in the HTTP specification, browsers will not open more than two connections to one server. This recommendation is not unreasonable, and is intended to encourage the use of HTTP pipelining. However in practice, better results are often achieved with less pipelining and more server connections. Servers frequently engineer their pages in such a way that this recommendation is bypassed. The common technique is used to make the server available under multiple DNS names, and load resources from these various DNS names. This technique is ineffective in general, since it requires HTML code on servers to be written (or re-written) in a manner to support it. However, according to one embodiment, the need to modify the HTML code is obviated by opening separate server connections directly to obtain the resources. This makes the web page load faster. In practice, empirical evidence shows that opening more connections is beneficial, and that the recommendation in the specification is counterproductive. For example, if two connections were optimal, then Facebook pages would load far slower, since Facebook opens numerous connections to obtain and render content in different sections of a single page more efficiently. This technique can only be used by the specifically prepared website since it requires modifying HTML code and server configuration.

Conversely, according to one embodiment, the parallel process for fetching the resources can transparently increase the number of connections open to a given website, without changing the website—indeed, without the website even being aware of this happening. The embodiment can do this by opening a new HTTP connection request for each resource it identifies, so these resources arrive independently in parallel via multiplexing. This can still be beneficial because gaps or pauses in the transmission of one resource (possibly caused by the behavior of TCP) could be “filled in” by the transmission of other resources. The trade-off between speed and the number of connections open can then be exploited.

The connection to the server may be normal HTTP or HTTPS connections over TCP. A given client can technically open a very large number of connections to the same port on the server (up to 65535, more than is practically required). The server will serve these connections independently. Servers could theoretically limit the number of connections they will accept from a given client, but these limits are very high in practice when they exist, because of the practice of using NATs by some ISPs and enterprises, which makes it look to the server as if a large number of different clients are actually just one.

In one embodiment, it is not required to use one new connection per identified resource. Any number of connections is possible. The number of connections can be set anywhere along a continuum from no new connections to one connection for each resource. At one extreme, the system can use two connections per hosting server, as per the recommendations. At the other extreme, the system can open as many connections as there are needed resources. Tests indicate that this may be optimal. In practice, the system may choose a number of connections based on a variety of factors, depending on the number and size of resources, the bandwidth of the available physical connections, network traffic, and so on. For example, out of concern for the recommendation of the HTTP document or to conform to possible server limitations, the system might choose a lower number of connections. In practice however, servers do not normally impose limits on the number of connections. This is in part due to the presence of proxies, which make it difficult or impossible to identify and distinguish individual client browsers.

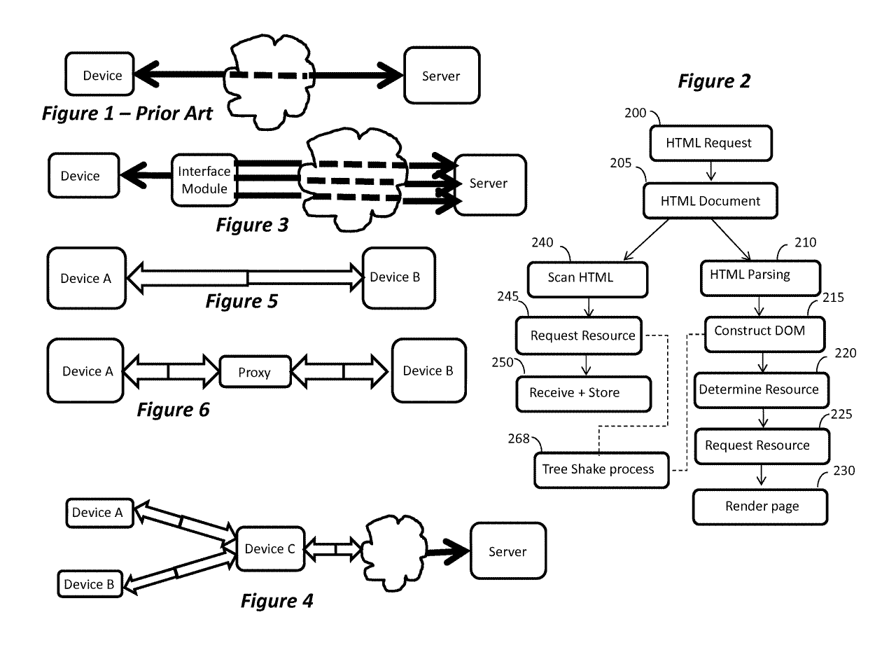

An illustration of the multiple connections embodiment is illustrated in FIG. 3. As noted, FIG. 1 illustrates a connection from a device to a server according to the prior art. FIG. 3 illustrates how the situation changes with the introduction of the disclosed embodiment. As shown, as far as the user's device, i.e., the browser is concerned, it sees only one connection to a single DNS address. However, an interface module is positioned between the device and the server and intercepts communications between the browser and the server. The interface module supports multiple connections to the server, using the same DNS address, and may implement parallel downloading of HTML pages and resources over the multiple connections. While in FIG. 3 the interface module is shown positioned between the device and the Internet, it may be positioned anywhere in the logical connection between the browser and the server. Thus, the interface module may be a software module residing on the same physical user device and the browser, inside the modem, inside the ISP server, etc. The interface module may be a separate hardware device connected to the modem, the ISP, or the hosting server. The interface sends each request to the same DNS address, but utilizes different originating names, such that to the website hosting server the requests appear as originating from different processes or browsers.

### 3. Wireless Caching

According to another embodiment, webpage resources are stored in various nodes in the network to be fetched when needed. One example uses proxies in end-systems, which entails sending requests from one end system to another. An “end system” can be a mobile device, a laptop, a desktop, a fixed router, a wireless router, a device in the Internet of Things, i.e., any device with an Internet connection and which is connected to the network. This embodiment achieves performance savings in the following way. Referring to FIG. 4, if two devices A and B ask for the identical resource from some third device C as shown in FIG. 3, then C can just fetch it once from the server and give it to both A and B.

Further, given the same connectivity among A, B, and C, if a device A doesn't have a resource, but B does, then if A sends a request to C for the resource, before forwarding this request to the network, C can first check to see if B has it. Device C can know this, for example, by remembering if it has previously satisfied a request for the resource from B. If so, C can direct A to obtain the resource from B if it isn't still in C's cache, or fetch it from device B and send it to device A. The simplified topology illustrated in FIG. 4 is only one example of many possible topologies and is provided as an example for easy understanding of the embodiment. However, the described behavior of using proxies at end-systems can happen in arbitrarily more complex topologies. FIG. 4 illustrates the general concept as simply as possible.

In general, the proxies discover cached resources on the network. In this context, “the network” refers to all the devices that a given device knows about and can access quickly, or rather, more quickly than it can access the hosting server. In practice, this may be those devices on a local area network or the set of devices which are in immediate wireless range of a given device, which may be beneficially queried before generating an Internet request. Sometimes the hosting server may be behind a slow link, or be overloaded. In which case, the notion of “network” maybe extended to the same city, or even same continent, i.e., to all connected devices from which a resource can be downloaded faster than from the hosting server. Since end systems can have resources cached, we consult these caches if an end system requests some set of resources, for example, the elements of a web page.

According to one example, resources in the network are found by using a distributed hash table (DHT). This hash table stores associations of the form <resource, location>. In one example, a mesh network may be constructed, on which this hash table resides. More generally, the system also works in two other situations: in local networks, and in wide area networks such as the Internet. The objects that can be referred to can be URIs or content hashes. E.g. SHA-256 hash values of the file content can be used to refer to the file, in other words, another way of naming the file. Content-addressable fetching is inherently secure since a device can determine if it received what it requested for by simply computing the hash value and seeing if it matches. In one system, the local network on which it operates is explicitly built. Connections between devices are established, and then these connections are used to distribute these objects. In this way, another method of speeding up web page loading is achieved.

### 4. Distributed DNS

The wireless caching technique described in the previous section can be extended. In addition to caching HTTP resources, the same can be done for DNS. Both DNS address queries and responses (domain names and IP addresses) are short, so a DNS query can be passed around the network. If any device already has the answer in its local cache, it doesn't need to be fetched from DNS servers on the Internet. All the techniques described above apply equally to DNS queries and responses as they do to other resources.

DNS query results can be cached in a distributed hash table, i.e. these DNS query results are distributed and cached throughout a wireless mesh network. When a DNS query is propagated through the wireless mesh network, each node that receives it attempts to satisfy it based on its own knowledge of its local cache. If it can satisfy the query without propagating it further, it does so. If no node on the propagation path is able to answer the query based on its local cache, it performs a lookup in the DHT (distributed hash table mentioned above) and simultaneously sends the query out to the Internet, then returns either the response it receives from the DHT or from the DNS server, whichever it receives first.

### Implementation Techniques

Modern web browsers are still slow compared to an optimal implementation. The disclosed improvements can be made to browsers themselves, and can also be placed outside web browsers, in different technological niches:
1. direct improvements to the browser itself
2. as a browser extension
3. additional software that can run where the browser runs, e.g., on the same physical device as the browser
4. software modifications “in-the-network” (i.e. in a network router—either a user's or an ISP's)
5. additional software on the website host server

Several implementation techniques are provided herein as examples:

Modify the browser. This is possible since most (if not all) browsers aside from Internet Explorer are open-source. (Safari, Chrome, Opera, Android browser, Mobile Safari, are all based on Webkit, which is open-source. Firefox, while not based on Webkit, is still open-source.) Fortunately, this is not always necessary. It is possible to implement this technique in other places in the technology stack.

Build a browser extension. We do not need the browser source code to accomplish this. While a browser extension is an acceptable place for these techniques to reside, there are even better ones, such as the following:

Introduce an additional piece of software on the computer. This software requires transparent proxy capability, i.e. a proxy through which all web traffic passes. This software resides between the network interface and the browser. (This approach is akin to the man-in-the-middle analogy of a security attack). This software knows to forward HTTP packets it receives from the network interface to the web browser and to send HTTP packets it receives from the browser to the network interface. This software can identify resources in HTML files it receives from the network interface and perform the heuristic preloading. Then, when it sees a browser requests for resources, it can immediately supply those resources to the browser since it has already downloaded and cached them.

There are multiple ways by which this software can be connected to the browser. The browser can use any of the following:
1. an HTTP proxy setting, which may be browser-wide or system-wide
2. an automatically configured proxy (browsers contain mechanisms to find proxies they're supposed to use)
3. a SOCKS proxy, which tells browsers to open a TCP connection
4. a transparent proxy, which intercepts and redirects all traffic from the network to the browser
5. an automatically configured HTTP proxy

All variations of this method that route the traffic through the system may be utilized. In general, a configuration such as the one shown in FIG. 5 is transformed into the one shown in FIG. 6, wherein a proxy is inserted between device A and device B. The basic idea is that opening a connection, reading from it and writing to it, are effectively “intercepted” by the proxy, which can interpose its own functionality such as detecting and anticipating potential resource requests, opening new HTTP connections to request them from a server (or transparently proxy these connections one-to-one), and satisfying them. For example, a SOCKS proxy allows the browser to open TCP connections to the proxy, start the proxy, and open connections to other hosts. All the above methods work on the same basic principle: substituting different procedures for standard UNIX network socket calls. So for example, the BSD socket connect call will now first connect to proxy. This also involves changing the UNIX load path in order to load the substitute libraries. There are several variations of implementations, all of which are well-understood techniques, the details of which (using such functions as tun, bpf, divert socket, raw socket, ipfilter, ipfw) are not of concern here. While the implementation details are not important, the main point is that it is possible to use UNIX mechanisms to build a transparent proxy, which makes it possible to insert any code implementing the embodiments between the browser and the network, and intercept all the browser's requests. The software mechanism can reside in a router or appliance through which the traffic passes. Such an appliance could be a simple box that one plugs into one's home router to make one's web pages run faster. Here are four possibilities for locating this software mechanism:
in a router in a home
in a router at an ISP
in an appliance in a home
in an appliance at an ISP.

It should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein.

The present invention has been described in relation to particular examples, which are intended in all respects to be illustrative rather than restrictive. Those skilled in the art will appreciate that many different combinations of hardware, software, and firmware will be suitable for practicing the present invention. Moreover, other implementations of the invention will be apparent to those skilled in the art from consideration of the specification and practice of the invention disclosed herein. It is intended that the specification and examples be considered as exemplary only, with a true scope and spirit of the invention being indicated by the following claims.

1. A computerized method for speeding up the downloading and rendering of web pages from a server, comprising:
during download and parsing of an HTML document by a browser, performing a secondary process comprising scanning the HTML document for mention of a resource and, upon encountering mention of a resource, fetching the resource from the server prior to the browser requesting the resource.

2. The method of claim 1, wherein the scanning and fetching is performed in parallel with but independently of the browser's processing of the HTML document.

3. The method of claim 1, wherein scanning is performed by intercepting the HTML document transmission from the server to the browser.

4. The method of claim 3, further comprising intercepting all requests sent from the browser to the server and determining whether the request can be fulfilled using resources available from other devices and, if so, fetching found resources from the other device and providing the found resources to the browser without sending the request to the server.

5. The method of claim 1, wherein fetching is performed by initiating a secondary connection to the server.

6. The method of claim 1, wherein scanning comprises searching for pattern matching.

7. The method of claim 1, wherein resources are identified by searching for tag types, file types, or specific text characters.

8. The method of claim 1, further comprising intercepting a request for a resource issued by the browser and determining whether the resource has been already downloaded and if so providing the resource to the browser; otherwise, relaying the request to the server.

9. The method of claim 3, further comprising intercepting a request for a resource issued by the browser and determining whether the resource has been already downloaded and if so providing the resource to the browser; otherwise, relaying the request to the server.

10. The method of claim 1, further comprising, for each resource, establishing a separate network connection to the server.

11. The method of claim 1, further comprising performing a process of tree shaker to identify all unused resources that are not utilized to render the web page and eliminating downloading of the unused resources.

12. A method for improving efficiencies of web browsers, comprising:
inserting a proxy module between the browser and a website hosting server;
preprogramming the proxy to:
detect a request for a webpage issued by the browser;
intercept the webpage when received from the website hosting server while allowing the webpage to proceed to the browser for parsing;
inspecting the webpage for listed resources;
sending a request to the website hosting server for each resource listed in the webpage;
upon detecting a transmission for a requested resource issued by the browser to the website hosting server, determining whether the requested resource has been already downloaded and, if so, providing the resource to the browser and preventing the transmission from reaching the website hosting server.

13. The method of claim 12, further comprising storing a hash value for each resource downloaded.

14. The method of claim 13, further comprising: upon intercepting a transmission for a requested resource, determining whether hash value of the requested resource matches a stored hash value and, if so, fetching a cached resource matching the hash value and providing the cached resource to the browser.

15. The method of claim 12, wherein the resource is at least one of Javascript code and cascading style sheets.

16. The method of claim 12, wherein whenever a webpage resource is requested from the website hosting server, the resource sent by the website hosting server is cached in a node of a network and when another request is made for the same resource, the resource is provided from the node and the request is not sent to the website hosting server.

17. The method of claim 16, further comprising storing a hash value corresponding to the resource together with identification of stored location.

18. The method of claim 17, further comprising maintaining a hash table of all hash values of resources stored on nodes connected to the network together with addresses corresponding to the notes in which the resources are stored.

19. The method of claim 12, further comprising intercepting DNS queries issued by the browser and determining whether corresponding web address is stored on a node and, if so, fetching the web address and providing it to the browser; otherwise, relaying the DNS query to a DNS server.

20. The method of claim 19, further comprising storing hash value of each intercepted DNS request in a distributed hash table.

21. The method of claim 20, wherein the distributed hash table is stored on multiple nodes on a network.

22. The method of claim 12, further comprising: prior to sending a request to the website hosting server for each resource listed in the webpage, determining whether to establish a new connection to the website hosting server based on examination of at least one of: number of resources listed in the webpage, size of the resource, bandwidth of available physical connections, and network traffic, and, if it was determined to establish a new connection, sending the request over the new connection; otherwise, sending the request over an existing connection.

23. The method of claim 22, further comprising downloading a plurality of resources in parallel over a plurality of connections.

24. The method of claim 12, further comprising performing a process of tree shaker to identify all unused resources that are not utilized to render the web page and eliminating downloading of the unused resources.

25. A computerized method for speeding up the downloading and rendering of web pages from a server, comprising:
Receiving an HTML document corresponding to the web page from a server;
parsing the HTML document;
constructing a document object model (DOM) corresponding to the web page;
traversing the DOM and enumerating all resources identified during traversal of the DOM;
intercepting a request for a resource from a browser issued to the server and determining whether the resource has been enumerated and, if so, relaying the request to the server, otherwise, voiding the request.

26. The computerized method of claim 25, wherein voiding the request comprises returning an error message to the browser.

27. The method of claim 25, further comprising when an outstanding request for resource is identified, checking whether the outstanding request is for a resource that has been enumerated during traversal of the DOM and, if not, closing a server connection for the outstanding request.
